(19) United States
(12) Patent Application Publication
(10) Pub. No.: US 2005/0278725 A1
(43) Pub. Date: Dec. 15, 2005

(54) Service search apparatus, service search method, and service search program

(76) Inventors: Takahiro Kawamura, Kanagawa (JP); Tetsuo Hasegawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/138,865

(22) Filed: May 27, 2005

(30) Foreign Application Priority Data
May 27, 2004 (JP) P.2004-158252

(51) Int. Cl. G06F 13/00

(52) U.S. Cl. 719/311; 719/318

(57) ABSTRACT

A service search apparatus to register plural pieces of service information provided by programs accessed through a network and search for service, includes a service registration unit to store identification information and service information containing access destination information, thereby registering the service and update the stored service information and a registration description, a service search unit, upon receiving a service search request, to search for the services and provide a search result, a service determination processing unit to perform at least one of three types of processing of determining importance in response to a use state, determining weighting responsive to logical matching with specific ontology or property, and determining a field responsive to a service provider, and store a result, and a reflection information providing unit to provide reflection information to reflect the result or the service information for the service search unit or the service registration unit.

### CROSS-REFERENCE TO RELATED APPLICATIONS

This application is based upon and claims the benefit of priority from the prior Japanese Patent Applications No. 2004-158252, filed on May 27, 2004; the entire contents of which are incorporated herein by reference.

### BACKGROUND OF THE INVENTION

1. Field of the Invention

This invention relates to an improvement in a service search art for registering externally accessible computer programs distributed on a network as service and searching for the service.

2. Description of the Related Art

Hitherto, search techniques used in a search apparatus for a service search on a network have been classified into three types of techniques using an IR technique of a keyword search and a text similarity search, using a logical technique of a semantic search according to an ontology and a condition search according to a rule, and using a hybrid technique.

On the other hand, a search apparatus for a Web page search such as Google™ or Yahoo! doesnot rely only on a keyword search or a text similarity search and also uses heuristic techniques of link popularity, weighting for each tag, and site theme for improving the search accuracy. (For example, refer to Motoharu Sumi, “SEO Search Engine Optimization Project,” D. Art Corporation, July, 2003, ISBN: 4-88648-699-1.)

However, it cannot be said that the three types of techniques used in the service search apparatus in the related art as described above has sufficient search accuracy, and it is difficult to bring the search result of the service search close to the intention of the user. In contrast, it is also considered that the heuristic technique contributing to the search accuracy improvement in the search apparatus for a Web page search is applied to the service search art. However, it is difficult to apply the heuristic technique generally used in the search apparatus for a Web page search to the service search apparatus in the related art as it is.

### SUMMARY OF THE INVENTION

The embodiment provides a service search apparatus, a service search method, and a service search program high in search accuracy for making it possible to bring the search result closer to the intention of the user by improving a heuristic technique for a Web page search so that the heuristic technique can be applied to a service search on a network.

The embodiment makes it possible to bring the search result closer to the intention of the user by performing processing of importance determination responsive to the service use state, service weighting determination responsive to specific ontology or property, service field determination responsive to a service provider, etc., and reflecting the processing result in the search result or registration information.

According to the embodiment, there is provided a service search apparatus to register a plurality of pieces of service information indicating a plurality of services provided by programs that can be accessed through a network and searching for service, the service search apparatus including a service registration unit, a service search unit, a service determination processing unit, and a reflection information providing unit. The service registration unit stores, for each service, identification information for identifying the service and service information containing access destination information indicating an access destination to the service as the plurality of pieces of service information, thereby registering the service and updates the stored service information, thereby updating a registration description of the service. Upon reception of a service search request through the network from a user terminal, the service search unit searches for the services in response to the service search request and provides a search result for the user terminal making the service search request. The service determination processing unit performs at least one of three types of processing of processing of determining importance in response to a use state of each service, processing of determining weighting responsive to logical matching of each service with specific ontology or property, and processing of determining a field responsive to a service provider for providing each service, and stores a processing result. Further, the reflection information providing unit is responsive to the processing result for providing reflection information to reflect the search result or the service information for the service search unit or the service registration unit.

According to the embodiment, there are provided a service search method and a service search program for representing the features of the service search apparatus from the viewpoints of a method and a program respectively.

According to the embodiment as described above, there can be provided the service search apparatus, the service search method, and the service search program high in search accuracy for making it possible to bring the search result closer to the intention of the user by improving the heuristic technique for a Web page search so that the heuristic technique can be applied to a service search on the network.

### BRIEF DESCRIPTION OF THE DRAWINGS

FIG. 1 is a block diagram to show an outline of the configuration of a service search system incorporating the embodiment;

FIG. 2 is a flowchart to show an outline of the operation of a service search apparatus shown in FIG. 1;

FIG. 3 is a block diagram to show an example of the configuration of a service popularity determination processing unit shown in FIG. 1;

FIG. 4 is a block diagram to show an example of the configuration of an ontology/property weighting determination processing unit shown in FIG. 1;

FIG. 5 is a block diagram to show an example of the configuration of a service theme determination processing unit shown in FIG. 1;

FIG. 6 is a flowchart to show an example of the specific operation of the service popularity determination processing unit shown in FIG. 3;

FIG. 7 is a flowchart to show an example of the specific operation of the ontology/property weighting determination processing unit shown in FIG. 4; and

FIG. 8 is a flowchart to show an example of the specific operation of the service theme determination processing unit shown in FIG. 5.

### DETAILED DESCRIPTION OF THE INVENTION

[System Configuration]

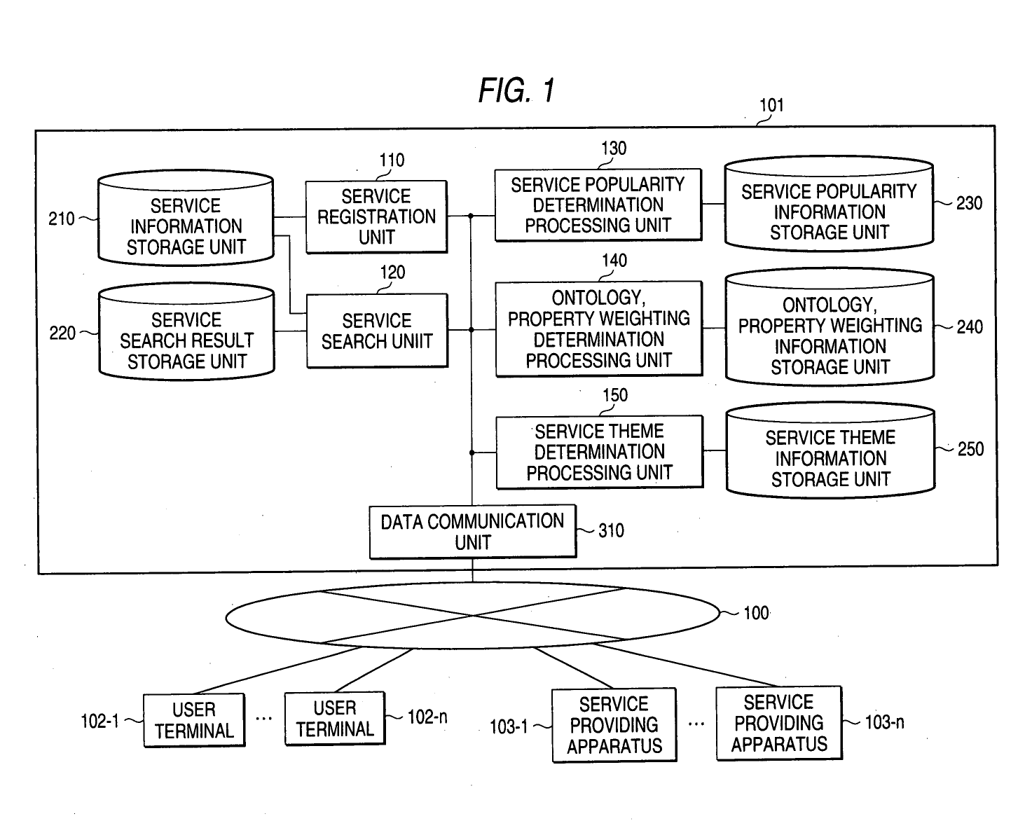

FIG. 1 is a block diagram to show an outline of the configuration of a service search system incorporating the embodiment. As shown in FIG. 1, a service search apparatus 101 according to the embodiment is connected to a network 100 such as the Internet and is connected through the network 100 to a plurality of user terminals 102-1 to 102-n. A plurality of service providing apparatus 103-1 to 103-n each for providing an externally accessible computer program as service are connected to the network 100, and the service search apparatus 101 registers and searches for the services provided by the service providing apparatus 103-1 to 103-n.

The service search apparatus 101 includes a service registration unit 110, a service search unit 120, a service popularity determination processing unit 130, an ontology/property weighting determination processing unit 140, a service theme determination processing unit 150, a service information storage unit 210, a service search result storage unit 220, a service popularity information storage unit 230, an ontology/property weighting information storage unit 240, a service theme information storage unit 250, a data communication unit 310, etc. The functions of these units are as follows.

The service registration unit 110 stores service information containing identification information for identifying the service and access destination information indicating the access destination in the service information storage unit 210 for each service as a plurality of pieces of service information in response to a command of the person in charge, thereby registering the service and updates the stored service information, thereby updating the registration description of the service. The term “person in charge” is used to mean the person in charge for performing some operation on the service search apparatus 101 for registering service through the service registration unit 110. The term “command of the person in charge” is used to mean a command given to the service search apparatus 101 in response to operation of the person in charge. In the specification, the term “update” of information is used as a wide concept including rewrite, addition, and deletion of the information.

Upon reception of a service search request through the network 100 from the user terminal 102, the service search unit 120 searches for the services registered in the service information storage unit 210 and provides the search result for the requesting user terminal 102 and also stores the service search result in the service search result storage unit 220.

The service popularity determination processing unit 130 performs processing of determining that the importance of the service is higher as the number of service flows using the service and the value of the use frequency of each of the service flows are high as service popularity determination processing concurrently in conjunction with the operation of the service search unit 120. In the specification, the service flow is information indicating what order a plurality of services are to be processed in, and is described in a service flow description file as described later.

The service popularity determination processing unit 130 also stores service popularity information provided as the processing result of the service popularity determination processing in the service popularity information storage unit 230 and provides the service search unit 120 with reflection information to update the service search result of the service search unit 120 in response to the service popularity information. That is, the service popularity determination processing unit 130 also has the function of a reflection information providing unit in addition to the function as the service popularity determination processing unit according to the embodiment.

The ontology/property weighting determination processing unit 140 performs ontology/property weighting determination processing. That is, if service logically matches with predetermined specific ontology or property, the ontology/property weighting determination processing unit 140 weights the importance of the service in response to the type of specific ontology or property. The ontology/property weighting determination processing unit 140 performs the ontology/property weighting determination processing concurrently in conjunction with the operation of the service search unit 120.

The ontology/property weighting determination processing unit 140 also stores ontology/property weighting information provided as the processing result of the ontology/property weighting determination processing in the ontology/property weighting information storage unit 240 and provides the service search unit 120 with reflection information to update the service search result of the service search unit 120 in response to the ontology/property weighting information. That is, the ontology/property weighting determination processing unit 140 also has the function of a reflection information providing unit in addition to the function as the ontology/property weighting determination processing unit according to the embodiment.

The service theme determination processing unit 150 performs service theme determination processing as follows. In response to the service providers for providing services, the service theme determination processing unit 150 assumes that a plurality of services provided on the site of a specific service provider belong to the same field, that the service flow provided on the site of a specific service provider belongs to the same field, and that the services used in the service flow also belong to the same field, and determines the field of each service. The service theme determination processing unit 150 performs the service theme determination processing concurrently in conjunction with the operation of the service search unit 120.

The service theme determination processing unit 150 also stores service theme information provided as the processing result of the service theme determination processing in the service theme information storage unit 250 and provides the service registration unit 110 with reflection information to update the service information stored/updated in the service registration unit 110 in response to the service theme information. That is, the service theme determination processing unit 150 also has the function of a reflection information providing unit in addition to the function as the service theme determination processing unit according to the embodiment.

The data communication unit 310 communicates with the user terminals 102, the service providing apparatus 103, and other various apparatus through the network 100.

The service search apparatus specifically is realized by main memory of a computer, a program specialized for service search, stored in the memory, a data processing unit of a CPU, etc., controlled by the program, a data storage unit of auxiliary storage for storing necessary data, a data communication unit of a modem, etc., and the like. The hardware resources mentioned here are basic components generally included in a computer and therefore will not be discussed again.

[Operation]

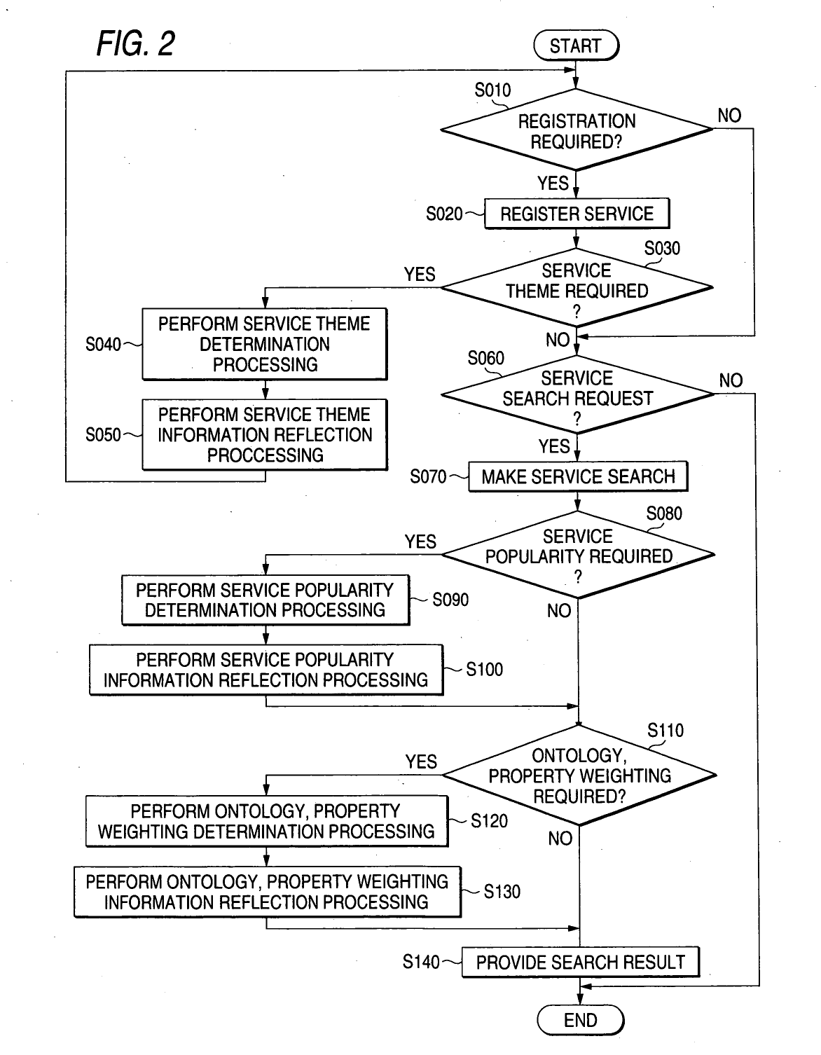

FIG. 2 is a flowchart to show an outline of the operation of the service search apparatus 101 according to the embodiment having the described configuration.

As shown in FIG. 2, the service search apparatus 101 previously registers a large number of services distributed on the network 100 in the service information storage unit 210 through the service registration unit 110 and whenever a new service occurs, registers the service in the service information storage unit 210 (YES at S010 and S020).

When the service is registered, if service theme information is required (YES at S030), the service theme determination processing unit 150 performs service theme determination processing (S040) concurrently with the service registration, and provides the service registration unit 110 with “service theme information reflection information” to reflect the service theme information provided as the processing result in the service information (S050).

In this case, the service registration unit 110 performs information rewrite, addition, deletion, etc., for the service information stored in the service information storage unit 210 or the current service information being processed, not yet stored in the service information storage unit 210 based on the “service theme information reflection information,” thereby updating the service information, and stores the post-updated service information in the service information storage unit 210 (S010 and S020).

The “service theme information reflection information” provided for the service registration unit 110 by the service theme determination processing unit 150 is a wide concept including various pieces of information to update the service information in response to the service theme information, and the service theme information may be used as it is. Alternatively, the service information after being updated in response to the service theme information may be used. That is, the service theme determination processing unit 150 functioning as the information reflection unit may update the service information using the “service theme information” provided by performing the service theme determination processing and may provide the post-updated service information for the service registration unit 110.

If a service search request is received from the user terminal 102 through the network 100 (YES at S060), the service search unit 120 searches for the services in the service information storage unit 210 (S070).

If service popularity information is required (YES at S080) at the service search time, the service popularity determination processing unit 130 performs service popularity determination processing (S090) concurrently with the service search and provides the service search unit 120 with “service popularity information reflection information” to reflect the service popularity information provided as the processing result in the service search result (S100).

If ontology/property weighting information is required (YES at S110) at the service search time, the ontology/property weighting determination processing unit 140 performs ontology/property weighting determination processing (S120) concurrently with the service search and provides the service search unit 120 with “ontology/property weighting information reflection information” to reflect the ontology/property weighting information provided as the processing result in the service search result (S130).

In this case, the service search unit 120 performs information rewrite, addition, deletion, etc., for the service search result stored in the service search result storage unit 220 or the current service search result being processed, not yet stored in the service search result storage unit 220 based on either or both of the “service popularity information reflection information” and the “ontology/property weighting information reflection information,” thereby updating the service search result. The service search unit 120 stores the post-updated service search result, namely, the service search result in which either or both of the service popularity information and the ontology/property weighting information is reflected in the service search result storage unit 220 and provides the service search result for the user terminal 102 making the service search request (S140).

The “service popularity information reflection information” and the “ontology/property weighting information reflection information” are each a wide concept including various pieces of information to update the service search result in response to the service popularity information or the ontology/property weighting information, and the service popularity information or the ontology/property weighting information may be used as it is. Alternatively, the service search result after being updated in response to the service popularity information or the ontology/property weighting information may be used. That is, the service popularity determination processing unit 130 or the ontology/property weighting determination processing unit 140 functioning as the information reflection unit may update the service search result using the service popularity information or the ontology/property weighting information provided by performing the determination processing and may provide the post-updated service search result for the service search unit 120.

If the service popularity information or the ontology/property weighting information is not required (NO at S80, NO at S110), the service search unit 120 provides the service search result intact for the user terminal 102 making the service search request (S140).

[Specific Examples of Processing Units]

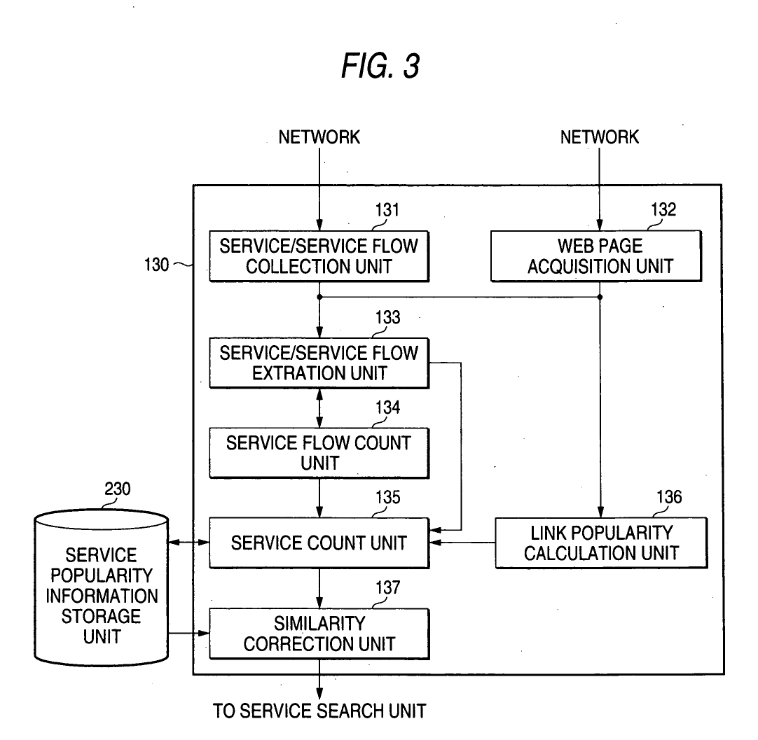

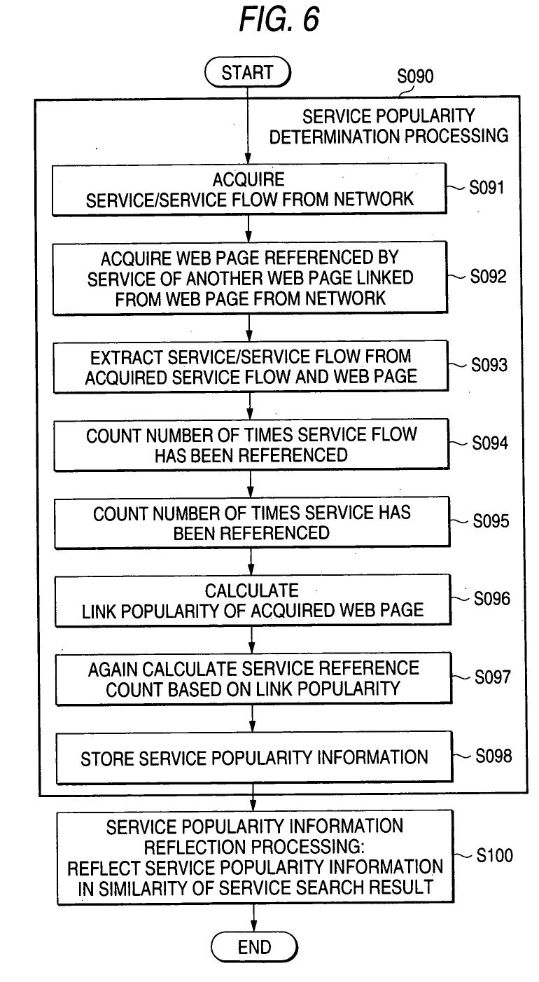

FIGS. 3 to 5 are block diagrams to show examples of the configurations of the three main processing units of the service search apparatus 101 according to the embodiment described above, namely, the service popularity determination processing unit 130, the ontology/property weighting determination processing unit 140, and the service theme determination processing unit 150. FIGS. 6 to 8 are flowcharts to show examples of the specific operation of the processing units 130, 140, and 150 shown in FIGS. 3 to 5. The specific examples will be discussed below in order with reference to FIGS. 3 to 8.

[Specific Example of Service Popularity Determination Processing Unit]

The service popularity determination processing unit 130 shown in FIG. 3 includes a service/service flow collection unit 131, a Web page acquisition unit 132, a service/service flow extraction unit 133, a service flow count unit 134, a service count unit 135, a link popularity calculation unit 136, a similarity correction unit 137, etc. In FIG. 3, the arrow from one block to another indicates a data flow. An example of the operation of the service popularity determination processing unit 130 will be discussed below with reference to FIG. 6.

As shown in FIG. 6, in service popularity determination processing (S090), the service/service flow collection unit 131 collects services and service flows from the network 100 (S091). Each service is described in a service description file and each service flow is described in a service flow description file, they can be acquired through the network 100. Here, by way of example, it is assumed that services and service flows as listed below in Table 1 can be acquired.

TABLE 1

```
  Service flow SF1:  Service S1, service S2, service S3
  Service flow SF2:  Service S2, service S3, service S4,
service flow SF1
  Service flow SF3:  Service S3, service S4, service S5
```

The Web page acquisition unit 132 acquires the Web page referenced by each service and another Web page linked from the Web page from the network 100 (S092). Here, by way of example, it is assumed that the Web page as listed below in Table 2 can be acquired.

TABLE 2
Web page WP1: Service S6, service S7

Next, the service/service flow extraction unit 133 extracts services and service flows from the service flows and the Web page acquired by the service/service flow collection unit 131 and the Web page acquisition unit 132 (S093). In the example, the services and the service flows as listed below in Table 3 are extracted from the service flows in Table 1 and the Web page in Table 2.

TABLE 3

| | |
|---|---|
| Service flows: | SF1, SF2, SF3 |
| Services: | S1, S2, S3, S4, S5, S6, S7 |

Next, the service flow count unit 134 counts the number of times each service flow has been referenced (S094). In the example, the number of times each service flow has been referenced is counted as listed below in Table 4 from Table 1. The “o” marks in Table 4 are used to represent the count as a graph.

TABLE 4

| | |
|---|---|
| Service flow SF1 | oo |
| Service flow SF2 | o |
| Service flow SF3 | o |

Further, the service count unit 135 counts the number of times each service has been referenced (S095). However, considering the number of reference times of the service flow of the reference source, the number of times each service in SF1 has been referenced is counted twice. The number of times the last service appearing in the flow has been referenced is also counted twice. In the example, the number of times each service has been referenced is counted as listed below in Table 5. The “o” marks in Table 5 are used to represent the count as a graph as in Table 4.

TABLE 5

| | |
|---|---|
| Service S1 | oooo |
| Service S2 | ooooo |
| Service S3 | oooooooooo |
| Service S4 | ooo |
| Service S5 | oo |
| Service S6 | o |
| Service S7 | o |

The link popularity calculation unit 136 calculates the link popularity of the acquired Web page (S096). It is assumed that the link popularity as listed below in Table 6 is calculated.

TABLE 6
Web page WP1: 3

Subsequently, considering the link popularity of the Web page of the reference source, the service count unit 135 again calculates the service reference count (S097). Here, it is assumed that the value of the link popularity in Table 6 is used as it is and the number of times each WP1 service has been referenced is counted three times. Consequently, the service reference counts in Table 5 are corrected as listed below in Table 7. The service count unit 135 stores the service reference counts corrected as in Table 7 in the service popularity information storage unit 230 as service popularity information (S098).

TABLE 7

| | |
|---|---|
| Service S1 | oooo |
| Service S2 | ooooo |
| Service S3 | oooooooooo |
| Service S4 | ooo |
| Service S5 | oo |
| Service S6 | ooo |
| Service S7 | ooo |

Last, the similarity correction unit 137 reflects the service popularity information in the similarity of the service search result provided by the service search unit 120 as service popularity information reflection processing (S100). For example, if it is determined that the services S1 and S3 are of the same similarity as the result of service search based on text processing or logical processing, the service S3 is placed above the service S1 in the search result list from the service popularity information listed in Table 7.

[Specific Example of Ontology/Property Weighting Determination Processing Unit]

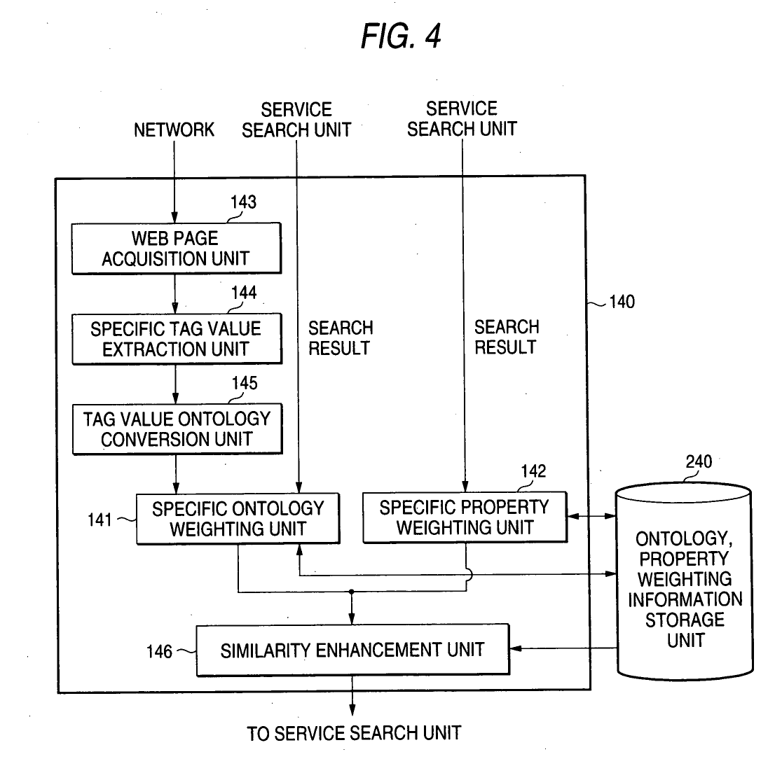

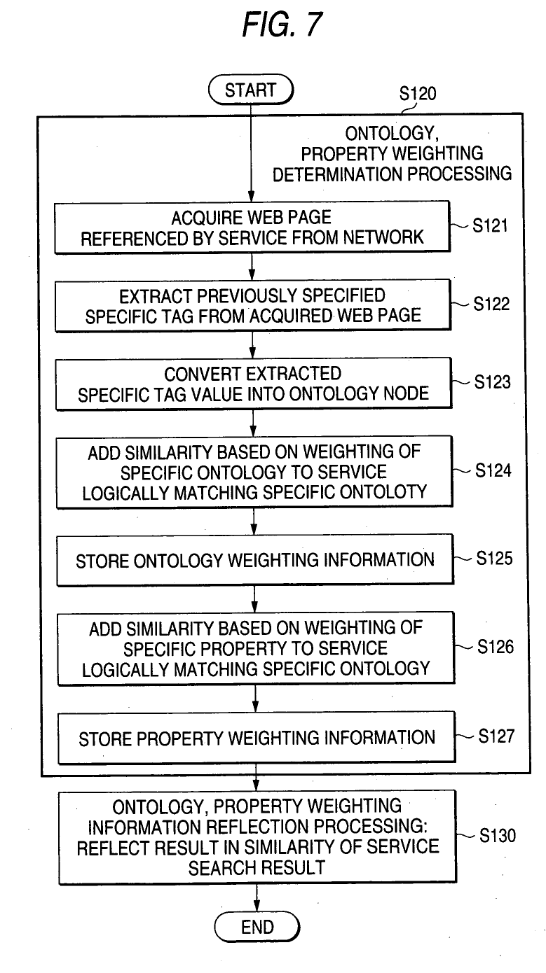

The ontology/property weighting determination processing unit 140 shown in FIG. 4 includes a specific ontology weighting unit 141, a specific property weighting unit 142, a Web page acquisition unit 143, a specific tag value extraction unit 144, a tag value ontology conversion unit 145, a similarity enhancement unit 146, etc. In FIG. 4, the arrow from one block to another indicates a data flow. An example of the operation of the ontology/property weighting determination processing unit 140 will be discussed below with reference to FIG. 7.

As shown in FIG. 7, in ontology/property weighting determination processing (S120), the Web page acquisition unit 143 acquires the Web page referenced by service from the network 100 (S121). Here, by way of example, it is assumed that service S1 reference Web page WP1 as listed below in Table 8.

TABLE 8
Service S1 -> Web page WP1

Next, the specific tag value extraction unit 144 extracts the previously specified important tag value from within the acquired Web page (S122). Here, by way of example, it is assumed that the value of classification tag as listed below in Table 9 is acquired.

TABLE 9
<classification>4WD</classification>

The tag value ontology conversion unit 145 converts the extracted specific tag value into an ontology node which seems to be most conceptually similar (S123). Here, the tag value 4WD in Table 9 is converted into SUV node of Vehicle ontology as listed below in Table 10.

TABLE 10
4WD = vehicle.owl#SUV

The specific ontology weighting unit 141 adds similarity if service logically matches with respect to a specific ontology tree or a node in the tree as specific ontology weighting processing (S124). As a general rule, processing of enhancing the similarity as the node appears in the lower rank in the ontology tree can also be performed. Here, by way of example, it is assumed that the node SUV in the Vehicle ontology is weighted three times as listed below in Table 11. The specific ontology weighting unit 141 stores the information thus provided in the ontology/property weighting information storage unit 240 as ontology weighting information (S125).

TABLE 11
vehicle.owl#SUV: x3

The specific property weighting unit 142 adds similarity if service logically matches with respect to a specific property as specific property weighting processing (S126). As a general rule, weighting can also be performed in the order of output and input with the category representing the whole service as the maximum among various service properties. Here, by way of example, it is assumed that the category property is weighted twice as listed below in Table 12. The specific property weighting unit 142 stores the information thus provided in the ontology/property weighting information storage unit 240 as property weighting information (S130).

TABLE 12
<category>: x2

Last, the similarity enhancement unit 146 reflects the result provided by performing the ontology/property weighting processing in the similarity of the service search result provided by the service search unit 120 as ontology/property weighting information reflection processing (S130).

For example, if service St and Sa1, Sa2 are of the same similarity X as the result of service search based on text processing or logical processing, the similarity of Sa2 is enhanced twice from Table 12 as listed below in Table 13.

TABLE 13

```
  Service St:  <category>vehicle.owl#Car</category>
  Service Sa1:  <category>vehicle.owl#Track</category>
X*1
  Service Sa2:  <category>vehicle.owl#Car</Category>X*2
```

If service Ss and Sa3, Sa4 are of the same similarity X as the result of service search based on text processing or logical processing, the similarity of Sa4 is enhanced three times from Table 11 as listed below in Table 14.

TABLE 14

Service Ss: <output>vehicle.owl#SUV</output>
Service Sa3: <output>vehicle.owl#Track</output> X*1
Service Sa4: <output>vehicle.owl#SUV</output> X*3

[Specific Example of Service Theme Determination Processing Unit]

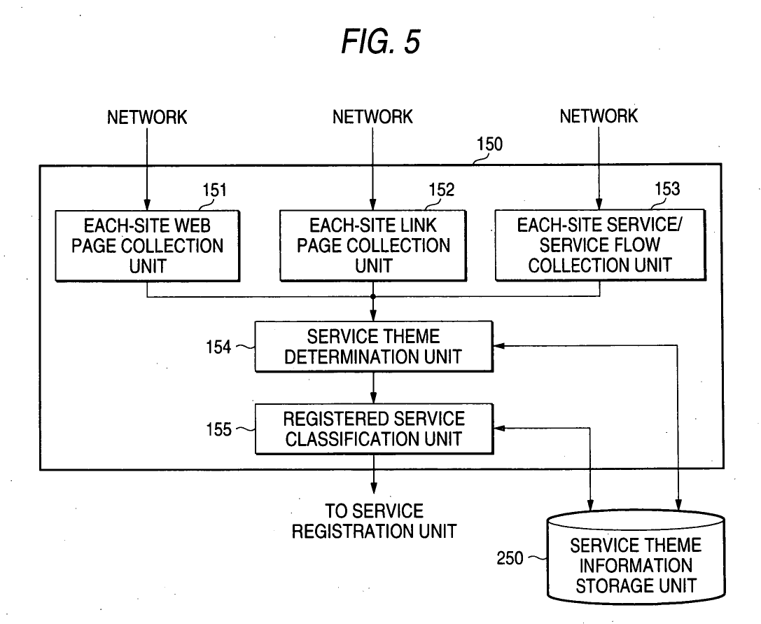

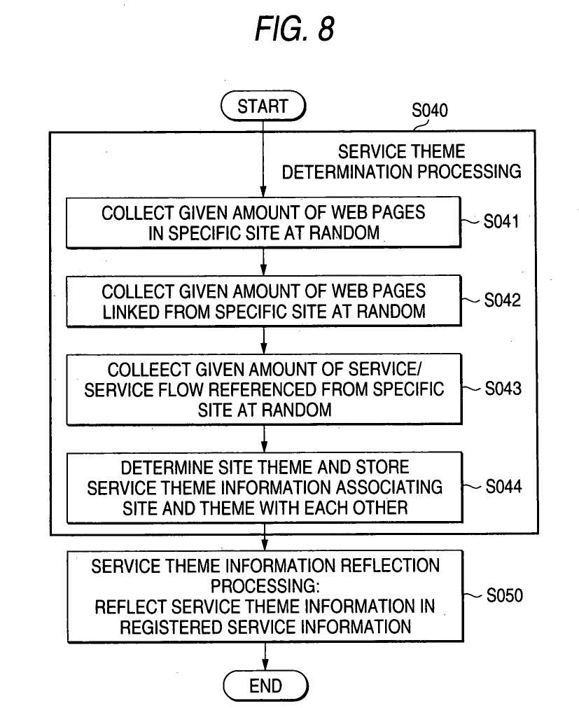

The service theme determination processing unit 150 shown in FIG. 5 includes an each-site Web page collection unit 151, an each-site link page collection unit 152, an each-site service/service flow collection unit 153, a service theme determination unit 154, a registered service classification unit 155, etc. In FIG. 5, the arrow from one block to another indicates a data flow. An example of the operation of the service theme determination processing unit 150 will be discussed below with reference to FIG. 8.

As shown in FIG. 8, in service theme determination processing (S040), the each-site Web page collection unit 151 collects at random a given amount of Web pages in a specific site separated by one IP domain (S041). Here, by way of example, it is assumed that Web page WP1 is obtained from site A and a tag named category exists in WP1 as listed below in Table 15.

TABLE 15
Site A Web page WP1: <category>car</category>

The each-site link page collection unit 152 collects at random a given amount of Web pages linked from a specific site collecting Web pages (S042). Here, by way of example, it is assumed that Web page WP2 linked from site A is obtained and the category tag of WP2 is described as listed below in Table 16.

TABLE 16
Site A Web page WP2: <category>automobile</category>

Further, the each-site service/service flow collection unit 153 collects at random a given amount of service and service flow referenced from a specific site and service further referenced from the service flow (S043). Here, by way of example, it is assumed that service S1 and service flow SF1 are found and service S2 is found as service further referenced from the service flow SF1 and they are described as listed below in Table 17.

TABLE 17

```
Site A service S1:  <category>Car Selling</category>
  service flow SF1:  <category>Vehicle</category>
  -> service S2:  <category>Track</category>
```

Subsequently, the service theme determination unit 154 determines the site theme based on a given rule from metainformation and text within the collected Web page, metainformation, category information, input/output, etc., of the collected service and service flow, and stores service theme information associating site IP domain information and theme with each other in the service theme information storage unit 250 (S044). Here, by way of example, it is assumed that site A is determined an automobile selling site as listed below in Table 18.

TABLE 18
Site A = automobile selling

Last, the registered service classification unit 155 reflects the generated service theme information in the service information registered by the service registration unit 110 (S050). If the new registered service is a service in the IP domain, the service is classified for each predetermined theme for storage. If a theme is specified at the service search time, the service theme information can be used to narrow down the target registered services, etc., as listed below in Table 19.

TABLE 19

if service Sx is in site A, then service Sx = automobile
selling

If the theme of the site is not yet determined, the theme is determined and is stored based on a given rule from the service input/output combination. For example, if input is money and output is car, the theme is determined automobile selling.

[Advantages]

As described above, according to the embodiment, processing of importance determination responsive to the service use state, service weighting determination responsive to specific ontology or property, service field determination responsive to the service provider, etc., is performed and the processing result is reflected in the search result or registration information, whereby the search result can be brought closer to the intention of the user.

### Other Embodiments

The invention is not limited to the specific embodiment described above and other various modifications can be made without departing from the scope of the invention. For example, the apparatus configuration and the configurations of the processing units previously described with reference to the accompanying drawings are only illustrative and a specific function configuration can be selected appropriately. The flowcharts of FIGS. 6 to 8 are only illustrative and a specific operation procedure and details of each processing can be selected appropriately.

1. A service search apparatus to register a plurality of pieces of service information indicating a plurality of services provided by programs that can be accessed through a network, and to search for service, the service search apparatus comprising:
a service registration unit configured to store, for each service, identification information to identify the service and service information containing access destination information to indicate an access destination to the service as the plurality of pieces of service information, thereby registering the service, and to update the stored service information, thereby updating a registration description of the service;
a service search unit, upon reception of a service search request through the network from a user terminal, configured to search for the services in response to the service search request and to provide a search result for the user terminal making the service search request;
a service determination processing unit configured to perform at least one of three types of processing of processing of determining importance in response to a use state of each service, processing of determining weighting responsive to logical matching of each service with specific ontology or property, and processing of determining a field responsive to a service provider to provide each service, and to store a processing result; and
a reflection information providing unit, being responsive to the processing result, configured to provide reflection information to reflect the search result or the service information for the service search unit or the service registration unit.

2. The service search apparatus as claimed in claim 1, wherein
the service determination processing unit includes a service popularity determination processing unit configured to perform processing of determining that an importance of the service is higher as a number of service flows using the service and a value of a use frequency of the service flow are higher.

3. The service search apparatus as claimed in claim 2, wherein
the service popularity determination processing unit adds an importance of a Web page referenced by the service or an importance of a different Web page linked with the Web page at a preset ratio to the importance determined for the service.

4. The service search apparatus as claimed in claim 2, wherein
the service popularity determination processing unit determines that the importance of the service is higher as an appearance position of the service in the service flow is more downstream.

5. The service search apparatus as claimed in claim 2, wherein
when the service exists on a path through which the service always passes or on a path through which the service passes at relatively high frequency, the service popularity determination processing unit determines that the importance of the service is higher than that of any other service.

6. The service search apparatus as claimed in claim 1, wherein
the service determination processing unit includes an ontology/property weighting determination processing unit configured to weight the importance of the service in response to a type of specific ontology or property when the service logically matches with the predetermined specific ontology or property.

7. The service search apparatus as claimed in claim 6, wherein
the ontology/property weighting determination processing unit places prime importance on a property representing a category of a whole of each service and places higher importance on output property than input property in service input/output.

8. The service search apparatus as claimed in claim 6, wherein
the ontology/property weighting determination processing unit increases the importance of the service, when the service logically matches with an ontology node semantically identical with a value assigned to a feature tag in a referenced Web page.

9. The service search apparatus as claimed in claim 6, wherein
the ontology/property weighting determination processing unit increases the importance of the service, when the service logically matches with a low-ranked ontology node representing a more detailed concept in ontology having a tree structure.

10. The service search apparatus as claimed in claim 1, wherein
the service determination processing unit includes a service theme determination processing unit configured to assume that a plurality of services provided on a site of a specific service provider belong to the same field in response to a service provider providing each of the service, that a service flow provided on a site of a specific service provider belongs to the same field, and that a service used in the service flow also belongs to the same field, thereby determining a field of each service.

11. The service search apparatus as claimed in claim 10, wherein
the service theme determination processing unit assumes that the service provided on the site of the specific service provider belongs to the same field as a Web page provided on the site or a different Web page linked with the Web page.

12. The service search apparatus as claimed in claim 10, wherein
the service theme determination processing unit determines a theme of the service from ontology combination added to input/output of the service.

13. A service search method to register a plurality of pieces of service information indicating a plurality of services provided by programs that can be accessed through a network and to search for service using a computer including a data communication unit, a data processing unit, and a data storage unit, the service search method comprising:
registering a service by storing, for each service, identification information to identify the service and service information containing access destination information to indicate an access destination to the service in the data storage unit as the plurality of pieces of service information, thereby registering the service, and by updating the stored service information, thereby updating a registration description of the service;
searching a service, upon reception of a service search request through the network from a user terminal by the data communication unit, by searching for the services by the data processing unit in response to the service search request, and by providing a search result for the user terminal making the service search request by the data communication unit;
processing a service determination by performing at least one of three types of processing of processing of determining importance in response to a use state of each service, processing of determining weighting responsive to logical matching of each service with specific ontology or property, and processing of determining a field responsive to a service provider to provide each service by the data processing unit, and by storing a processing result in the data storage unit; and
providing a reflection information, being responsive to the processing result, by providing reflection information to reflect the search result or the service information by the data processing unit.

14. A service search program for registering a plurality of pieces of service information indicating a plurality of services provided by programs that can be accessed through a network and searching for service, the service search program for causing a computer to provide:
a service registration means for storing, for each service, identification information for identifying the service and service information containing access destination information indicating an access destination to the service as the plurality of pieces of service information, thereby registering the service, and updating the stored service information, thereby updating a registration description of the service;
a service search means, upon reception of a service search request through the network from a user terminal, for searching for the services in response to the service search request and providing a search result for the user terminal making the service search request;
a service determination processing means for performing at least one of three types of processing of processing of determining importance in response to a use state of each service, processing of determining weighting responsive to logical matching of each service with specific ontology or property, and processing of determining a field responsive to a service provider for providing each service, and storing a processing result; and
a reflection information providing means, being responsive to the processing result, for providing reflection information to reflect the search result or the service information for the service search function or the service registration function.
